(19) United States
(12) Patent Application Publication
(10) Pub. No.: US 2002/0047542 A1
(43) Pub. Date: Apr. 25, 2002

(54) Exposure system

(75) Inventor: Takanobu Higuchi, Tsurugashima-shi (JP)

Correspondence Address: SUGHRUE, MION, ZINN, MACPEAK & SEAS, 2100 Pennsylvania Avenue, N.W., Washington, DC, 20037, US

(73) Assignee: PIONEER CORPORATION

(21) Appl. No.: 09/946,469

(22) Filed: Sep. 6, 2001

(30) Foreign Application Priority Data
Sep. 7, 2000 (JP) P2000-271012

(51) Int. Cl. H01J 7/24

(52) U.S. Cl. 315/111.21

(57) ABSTRACT

An exposure system is disclosed which exposes a resist surface 52a to an optical or electron beam in a process involving a chemically amplified resist. The exposure system comprises a chamber 20 for housing a blank optical disc 51, an e-beam column 10 for exposing the resist surface 52a of the blank optical disc 51 housed in the chamber 20, to the optical or electron beam, and a laser 31 for heating a resist 52 within the chamber 20, and heats the resist 52 after the resist 52 is exposed to the optical or electron beam, whereby the state of the resist after the exposure can be made uniform.

### BACKGROUND OF THE INVENTION

1. Field of the Invention

The present invention relates generally to exposure systems for exposing resists to an optical or electron beam, and particularly to an exposure system adapted for exposing chemically amplified resists.

2. Description of Related Art

Following the commercialization of DVDs (Digital Versatile Discs), suppliers are now positively engaged with R&D activity to develop next-generation DVDs, including systems that can record/reproduce HDTV-equivalent digital moving images for two or more hours. This requires that a 12 cm diameter single optical disc has a recording capacity of 25 to 50 gigabytes with a signal transfer rate of 30 to 50 megabits per second. To meet this requirement, read-only discs need to have a minimum pit length of about 0.15 μm and a track pitch of about 0.3 μm as their next-generation DVD standard.

Existing blank disc recording apparatuses are no longer able to record information as such tiny pits. Thus, it is obvious that new types of blank disc recording apparatuses having a better resolution must be developed. Some R&D papers report new blank disc recording apparatuses using a recording source such as an electron beam or far ultraviolet laser.

A high-resolution resist must be used to record information in the form of tiny pits. However, as its exposure properties, a resist satisfying the compatibility between high sensitivity and high resolution is generally hard to find. As one solution to this problem, the concept of chemical amplification has been proposed (H. Ito, C. G. Willson: Polym. Eng. Sci. Vol. 23 1012 (1983)). A chemically amplified resist based on chemical amplification means a resist that is formed by combining a photoacid generator for generating acids upon exposure to an optical or electron beam, with a polymer highly reactive with acids. Acids generated by exposure act as a catalyst to induce the polymer to chain-like chemical reactions, thereby providing a gain of 1 or more in amplifying the quantum yield which is indicative of occurrences of chemical reaction induced in the polymer with respect to an exposure dose. Currently, both positive and negative chemically amplified resists are commercially available, satisfying the compatibility between high sensitivity and high resolution. In the field of semiconductor devices, semiconductor products such as DRAMs are actually fabricated by a lithographic process involving a combination of a KrF excimer laser (wavelength: 248 nm) with a chemically amplified resist.

Due to its being subjected to chemical reactions, a positive chemically amplified resist exhibits a phenomenon (first phenomenon) which is a change in the shape of a resist pattern, depending on the time between exposure and post exposure bake steps. In a process of preparing a blank optical disc, it takes several hours from the start to the end of an exposure, and as a result of this long exposure time, the shape of pits formed in a region exposed immediately after the start of the exposure is different from that of pits formed in a region exposed immediately before the end of the exposure, thus making it difficult to maintain reliable signal quality over each optical disc produced.

The positive chemically amplified resist also exhibits a phenomenon (second phenomenon) which is its T-shaped cross section resulting from the formation of a dissolution inhibition layer on its surface. One cause of the second phenomenon is that the acids generated by exposure become deactivated through reaction with alkali, such as ammonia and amine, within the atmosphere. In currently available semiconductor fabricating processes, this problem is avoided by controlling the total amount of alkali within the atmosphere to levels of 1 ppb or less. However, similar techniques are not viable in eliminating the first phenomenon encountered in the blank disc preparation process due to its long exposure time, as mentioned above.

The first and second phenomena are encountered likewise in direct-write e-beam lithographic processes used in the manufacture of semiconductors, and it is reported that attempts have been made to eliminate these phenomena by depositing an acidic surface protective layer on a chemically amplified resist (F. Fujino, et al.: J. Vac. Sci. Technol. Vol. 11 2773 (1993)). However, this approach involves complicated steps and entails high manufacturing cost, and thus a technology that can ensure reliable signal quality with simpler steps is called for.

### SUMMARY OF THE INVENTION

It is, therefore, an object of the present invention to provide an exposure system, etc. adapted for a process using a chemically amplified resist, which is capable of making the state of the exposed resist uniform.

An exposure system according to the invention which exposes a resist surface of an object for exposure to an optical or electron beam, comprises a chamber for housing the object for exposure, exposure device for exposing the resist surface of the object for exposure to the optical or electron beam, and heating device for heating a resist exposed to the optical or electron beam by the exposure device, within the chamber.

According to this exposure system, the resist exposed to the optical or electron beam is heated by the heating device. Thus, when a chemically amplified resist is used, chemical reactions induced in its polymer proceed quickly, and the state resulting from the chemical reactions is substantially uniform over the entire resist surface, independently of the time from the start of exposure. To obtain such state which is substantially uniform over the entire resist surface, it may be arranged to either promote the chemical reactions induced in the polymer up to a stage of practical completion by heating the resist using the heating device, or stop heating at some point along the reactions. To obtain uniformity over the entire resist as a final result of the chemical reactions taking place thereover, the heating device may be set to appropriate heating time and temperature according to which region of the resist surface is heated. In this case, different heating time and temperature are set according to the timing for exposure to optical or electron beam radiation, whereby the above uniformity as a final result of the chemical reactions can be attained independently of the exposure timing. As to the mode of heating by the heating device, the resist surface may be heated wholly at once, partially for a number of times, or while continuously moved from one region for heating to another. The resist surface may also be heated from one exposed region to another. In this case, the interval between exposure and heating can be kept substantially constant over the entire surface, and this further keeps the formation of the dissolution inhibition layer substantially uniform over the entire surface. Therefore, uniformity in the exposed resist can be further improved.

Inside the chamber, there may be provided a turn table for placing the object for exposure, and a drive device for driving the turn table for rotation, and the exposure device lithographically expose the resist surface while the turn table is rotated by the drive device. In this case, the resist surface may be scanned for sequential exposure by moving the optical or electron beam in a direction of moving away from or closer to the center of rotation of the surface.

The heating device may be provided with a laser beam emitting device that irradiates the resist surface with a laser beam. In this case, the use of the laser beam permits partial heating of the resist surface, whereby the surface can be heated partially from one region to another according to the exposure timing.

Further, the laser beam emitting device may be located outside the chamber, and irradiate the resist surface by directing the laser beam emitted therefrom to the surface through a laser beam transmissive member provided in the chamber.

In this case, since the laser beam emitting device is located outside the chamber, even in the case of exposure to an electron beam, there is no danger of the laser beam emitting device adversely affecting the electron beam. Further, optical devices including a lens system for focusing the laser beam and a mirror for moving the region for irradiation with the laser beam may be located either inside or outside, or respectively inside and outside the chamber. Control device may be provided to control the exposure device, laser beam emitting device, and optical devices such that the resist surface is heated according to the exposing operation.

The heating device may be provided with a laser beam emitting device that irradiates the resist surface with a laser beam, and the device may irradiate the resist surface while the turn table is rotated by the drive device, whereby the exposed region of the resist by the exposure device is heated by following the exposure.

In this case, the exposed region of the resist is heated by following the exposure, whereby the time between exposure and heating can be kept substantially constant over the entire resist surface. Hence, the dissolution inhibition layer is formed substantially uniformly over the entire resist surface. Therefore, uniformity in the resist can be further improved. In this case, the resist surface can be scanned for sequential exposure by moving the optical or electron beam, for example, in a direction of moving away from or closer to the center of rotation of the surface, and the exposed region of the resist can be heated similarly by moving the laser beam in the direction of moving away from or closer to the center of rotation of the surface by following the exposure.

The laser beam emitting device may be located outside the chamber, and irradiate the resist surface by directing the laser beam emitted therefrom to the surface through a laser beam transmissive member provided in the chamber.

In this case, since the laser beam emitting device is located outside the chamber, even in the case of exposure to an electron beam, there is no danger of the device adversely affecting the electron beam. Further, optical devices including an optical system for focusing the laser beam and a mirror for moving the region for irradiation with the laser beam may be located either outside or inside, or respectively outside and inside the chamber. Control device may be provided to control the exposure device, laser beam emitting device and optical devices such that the resist surface is heated according to the exposing operation.

A control device may be provided to control the relationship between a position for irradiation with the optical or electron beam and a position for irradiation with the laser beam such that the region exposed to the optical or electron beam is irradiated with the laser beam after a predetermined time elapses from a reference time at which the region is exposed to the optical or electron beam.

In this case, the time between exposure and heating can be kept substantially constant over the entire resist surface, whereby the dissolution inhibition layer can be formed substantially uniformly over the entire resist surface. Therefore, uniformity in the exposed resist can be further improved.

It should be noted that the invention is not limited to modes of embodiment disclosed in the accompanying drawings by the above description in which reference symbols borrowed from the drawings are added parenthetically in order to facilitate the understanding of the invention.

### BRIEF DESCRIPTION OF THE DRAWINGS

FIG. 1 is a schematic showing an exposure system of the present invention;

FIG. 2 is an enlarged view of a mechanism for laser beam radiation;

FIG. 3 is a control block diagram showing the control system of an exposure system 100;

FIG. 4 is a diagram showing how a blank optical disc is irradiated with an electron beam and a laser beam; and

FIG. 5 is a diagram showing an example in which a concave mirror is arranged in place of a plane mirror for reflecting a heating laser beam.

### DETAILED DESCRIPTION OF THE PREFERRED EMBODIMENT

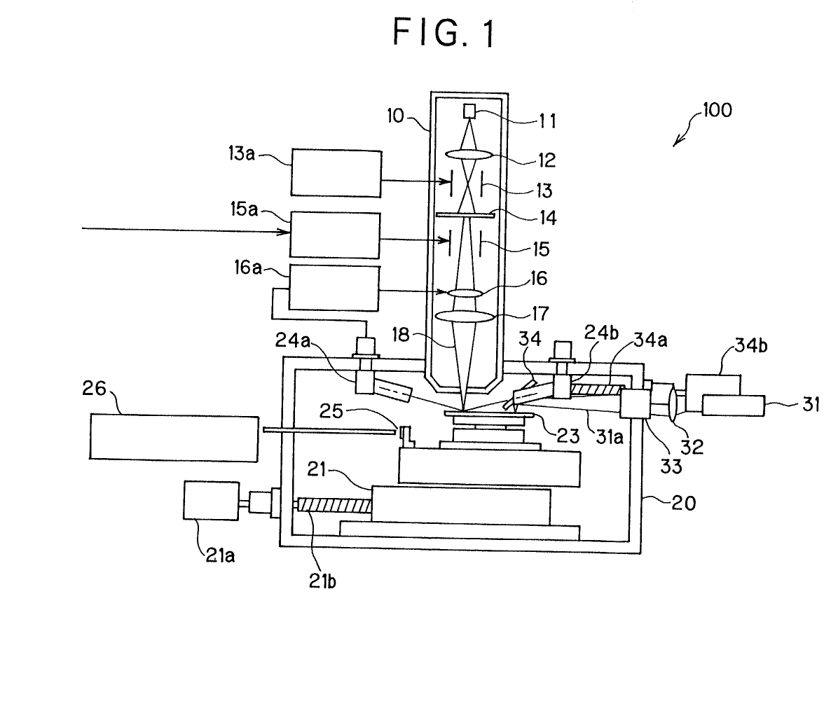

The present invention will now be described with reference to a preferred embodiment shown in FIGS. 1 to 4. An exposure system according to this embodiment is used in a process for fabricating blank optical discs.

FIG. 1 shows an exposure system 100 of the invention. As shown in the figure, the exposure system 100 includes an e-beam column 10 for directing an electron beam to a blank optical disc, and a vacuum chamber 20 for housing the blank optical disc.

The e-beam column 10 houses therein an emitter 11, a condenser lens 12, a beam deflector 13, an aperture 14, a beam deflector 15, a focusing lens 16, and an objective lens 17. An electron beam 18 emitted from the emitter 11 is focused at the beam deflector 13 by the condenser lens 12 to be modulated by a signal from a modulator 13a connected to the beam deflector 13. The modulated electron beam 18 is then restricted by the aperture 14. A beam position controller 15a is connected to the beam deflector 15. The controller 15a applies a signal to the deflector 15 to adjust the position for irradiation by the electron beam 18. Further, a focus controller 16a is connected to the focusing lens 16. The controller 16a applies a signal such that the focusing lens 16 adjusts the focus of the electron beam 18. The electron beam 18 having passed through the aperture 14, beam deflector 15, and focusing lens 16 is brought to focus on a resist surface of the blank optical disc by the objective lens 17.

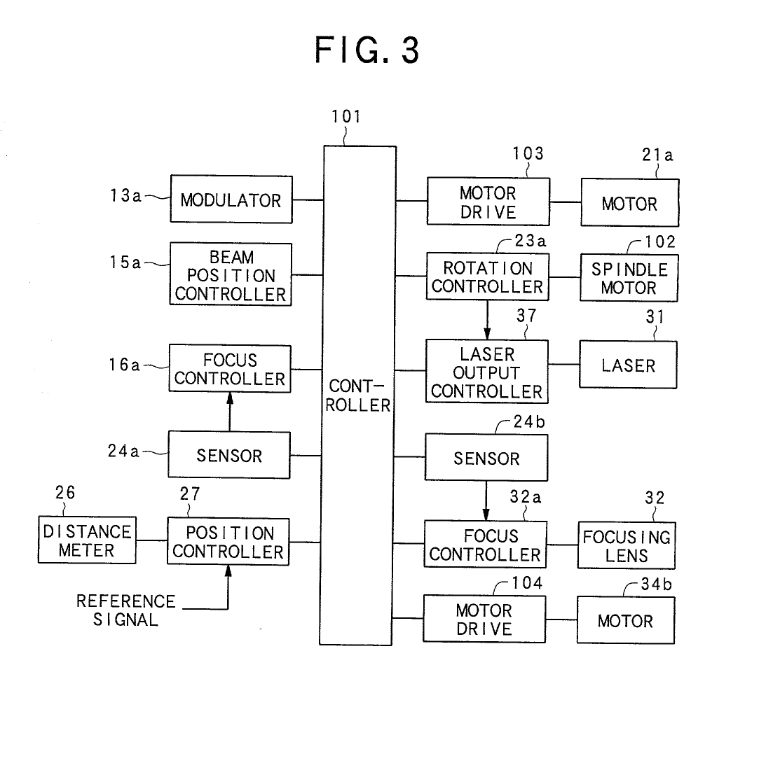

Inside the vacuum chamber 20 are an X stage 21, movable in both right and left directions (x directions) as viewed in FIG. 1, and a turn table 23 rotatably attached to the X stage 21. The stage 21 is driven by a motor 21a and a drive mechanism 21b. The motor 21a is driven by a motor drive 103 (FIG. 3). The turn table 23 is driven by an air-bearing type spindle motor 102 (FIG. 3) while directly coupled thereto. The air-bearings of the motor 102 are isolated from the vacuum chamber 20 through a differential exhaust mechanism or a magnetic fluid seal, etc., not shown, such that the air does not enter into the vacuum chamber 20. The spindle motor 102 receives a signal from a rotation controller 23a (FIG. 3), whereby the rpm of the turn table 23 is controlled.

The X coordinate of the axis of the turn table 23 is measured by a range meter 26. The meter 26 uses a laser interferometer that directs a laser beam to the mirror 25 attached to the X stage 21 and receives the reflected beam therefrom. A signal from the range meter 26 is applied to a position controller 27 (FIG. 3).

As shown in FIG. 1, sensors 24a and 24b are attached to the ceiling of the vacuum chamber 20. These sensors optically detect the vertical position of the resist surface of the blank optical disc.

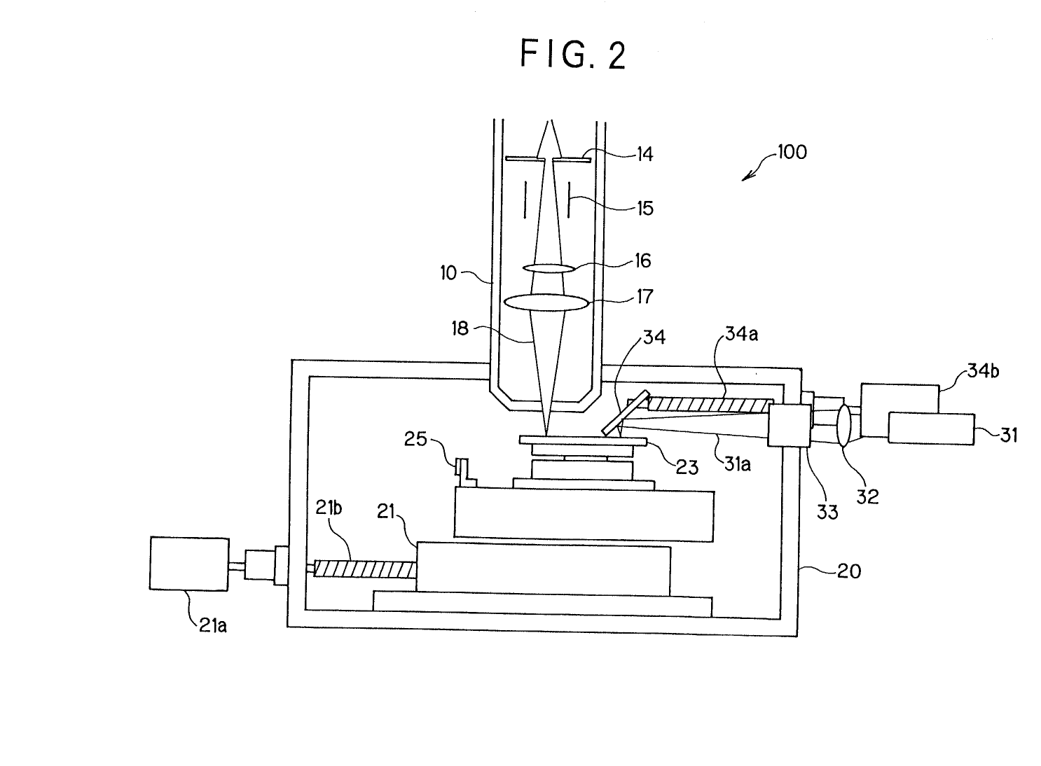

As shown in FIGS. 1 and 2, outside the chamber 20 are a laser 31 for emitting a red or infrared laser beam 31a for heating, and a focusing lens 32 for focusing the laser beam 31a emitted from the laser 31. A transmissive window 33 is formed in a side wall surface of the chamber 20 for transmission of the laser beam 31a therethrough. Inside the chamber 20 is a plane mirror 34, attached above the turn table 23, for bending the optical axis of the laser beam 31a. The plane mirror 34 is engaged with a drive mechanism 34a coupled to the rotary shaft of a motor 34b, whereby the position (or angle) of the mirror 34 can be varied relative to the turn table 23 as the motor 34b rotates. The motor 34b is driven by a motor drive 104 (FIG. 3).

The laser beam 31a emitted from the laser 31 is focused on the resist surface of the blank optical disc via the focusing lens 32, transmissive window 33, and plane mirror 34. The focal position of the laser beam 31a are moved in the x directions according to the position or angle of the mirror 34.

The output of the laser 31 (laser power) is controlled by a laser output controller 37 (FIG. 3).

As shown in FIG. 3, the modulator 13a, beam position controller 15a, focus controller 16a, sensors 24a and 24b, position controller 27, motor drive 103, rotation controller 23a, laser output controller 37, a focus controller 32a, and motor drive 104 are connected to a controller 101.

As shown in FIG. 3, a signal from the sensor 24a is applied to the focus controller 16a that controls the focusing lens 16 such that the electron beam 18 is always focused on the resist surface of the blank optical disc.

As shown in FIG. 3, the focal position of the heating laser beam 31a is controlled based on an output signal from the focus controller 32a, which controller, in response to a signal from the sensor 24b, controls the focusing lens 32 such that the laser beam 31a is always focused on the resist surface.

As shown in FIG. 3, the laser output controller 37 receives a signal from the rotation controller 23a. As will be described hereinafter, the output value of the laser 31 is controlled in accordance with the rpm of the turn table 23 so that the entire resist surface of the blank optical disc can be heated uniformly.

Next, an exposure step will be described, in which the blank optical disc is exposed using the exposure system 100 according to this embodiment.

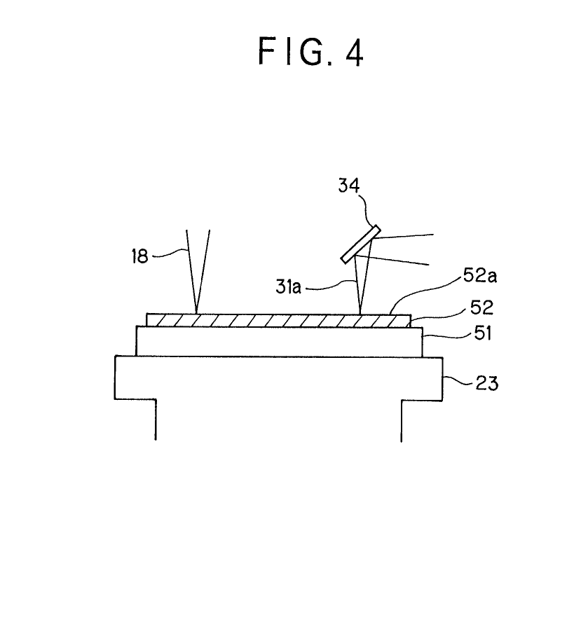

As shown in FIG. 4, a chemically amplified e-beam resist 52 is coated over the surface of a blank optical disc 51. After the disc 51 is fixed onto the turn table 23, the vacuum chamber 20 is evacuated by operating a vacuum pump (not shown).

Then, while exposing the e-beam resist 52 to the electron beam 18, the turn table 23 is rotated, and the X stage 21 is moved at the same time, whereby a spiral latent image consisting of a series of signals (the latent image of a pit array) is pressed into the e-beam resist 52. In the meantime, the position controller 27 receives an externally supplied reference signal and a distance signal from the range meter 26, and the X stage 21 is driven at a pre-programmed forwarding speed based on these signals. As mentioned above, the focusing lens 16 is controlled based on the signal from the sensor 24a for detecting a resist surface 52a, such that the electron beam 18 is always focused on the surface 52a during exposure by the beam 18.

On the other hand, the position for irradiation with the heating laser beam 31a is adjusted by controlling the position or angle of the plane mirror 34. The position or angle of the mirror 34 is controlled to keep the relative distance between the position for exposure to the electron beam 18 and the position for irradiation with the heating laser beam 31a such that a region exposed to the electron beam 18 is irradiate with the laser beam 31a after a preset time elapses from a reference timing at which the region is exposed to the electron beam 18. Therefore, irradiation with the heating laser beam 31a starts after a predetermined time elapses from the start of an exposure, and ends after a predetermined time elapses from the end of the exposure. As mentioned above, during irradiation with the heating laser beam 31a, the focusing lens 32 is controlled based on the signal from the sensor 24b for detecting the resist surface 52a such that the beam 31a is always focused on the surface 52a.

As a result of the irradiation with the heating laser beam, acid diffusion induced in the resist is practically completed, permitting no further progress of the reactions.

Although the position for irradiation with the electron beam must be controlled on the order of submicrometer, an accuracy of 1 to 10 micrometers would suffice to control the position for irradiation with the heating laser beam. This is because it takes only a short time period (a few seconds to minutes) to move the electron beam 18 by a distance of some micrometers in an x direction, and the state (sensitivity) of the chemically amplified resist would fluctuate but then settle within its tolerance during such a short time period as a few minutes. Hence, unlike in control over the position for exposure to the electron beam 18, a range meter using a laser interferometer is not employed in control over the position for irradiation with the heating laser beam 31a.

While the resist 52 is heated upon irradiation with the heating laser beam 31a, laser power must be controlled such that the heating condition is the same at any location of the blank optical disc 51, i.e., the disc 51 is heated to the same temperature all over its surface. To achieve this, it is required to control laser power such that a constant ratio is provided between laser power and the rotational speed of the blank optical disc 51, or more specifically, the traveling linear velocity of the blank disc 51 at the position for irradiation with the heating laser beam 31a. Such control is implemented by applying a signal from the rotation controller 23a that controls the rpm of the spindle motor 102, to the laser output controller 37 that controls laser power.

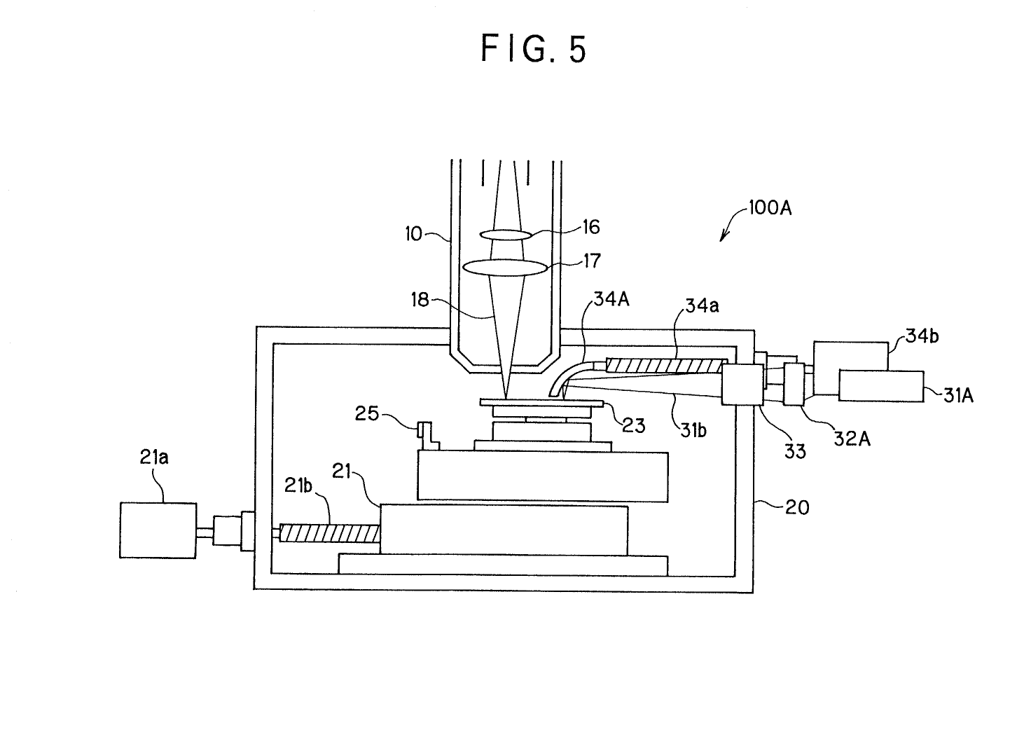

FIG. 5 shows an example in which a concave mirror is arranged in place of the plane mirror for reflecting the heating laser beam. In FIG. 5, the same components as those of the exposure system 100 are denoted by the same reference numerals, and their description is omitted.

As shown in FIG. 5, an exposure system 100A is constructed such that a laser beam 31b emitted from a laser 31A, passing through a focusing lens 32A and the transmissive window 33, reaches the concave mirror 34A thereby to be bent downward. The position or angle of the concave mirror 34A can be varied by rotating the motor 34b through the drive mechanism 34a. The focal position of the heating laser beam 31b is controlled by the focusing lens 32A.

In the configuration shown in FIG. 5, the NA of a lens for converging the heating laser beam 31b is determined by the concave mirror 34A. Since the mirror 34A can be located closer to the resist surface, a shorter focal distance and a larger NA can be provided. This, in turn, increases the energy density of the laser beam at the resist surface, and thus a low-power, inexpensive laser 31A can be used. Hence, a cost reduction can be achieved efficiently.

Since the laser 31 for heating the resist 52 is provided outside the vacuum chamber 20 in this embodiment, the flow of current through the laser 31 no longer disturbs electric fields within the vacuum chamber 20, and hence there is no danger that the electron beam will fluctuate. If the laser is provided inside the chamber, a magnetic shield is required. Further, in the case of exposure to an optical beam, current does not adversely affect the optical beam, and hence, there would be no such problem as encountered when the laser is provided inside the chamber in the case of exposure to an electron beam.

While exposure of a blank optical disc has been exemplified in the above description, the exposure system of the invention is applicable extensively to, e.g., fabrication of semiconductor products. Further, the exposure system is not limited to applications such as exposure to electron beam radiation, but applications such as exposure to optical beam radiation. Still further, the exposure system of the invention is applicable to exposing resists other than chemically amplified resists.

The entire disclosure of Japanese Patent Application No.2000-271012 filed on Sep. 7, 2000 including the specification, claims, drawings and summary is incorporated herein by reference in its entirety.

What is claimed is:

1. An exposure system that exposes a resist surface of an object for exposure to an optical or electron beam, comprising:
a chamber for housing said object for exposure;
exposure device for exposing said resist surface of said object for exposure housed in said chamber, to said optical or electron beam; and
heating device for heating a resist exposed to said optical or electron beam by said exposure device, within said chamber.

2. An exposure system according to claim 1, wherein a turn table for placing said object for exposure and drive device for driving said turn table for rotation are provided inside said chamber,
wherein said exposure device lithographically expose said resist surface while said turn table is rotated by said drive device.

3. An exposure system according to claim 1, wherein said heating device is provided with a laser beam emitting device for irradiating said resist surface with a laser beam.

4. An exposure system according to claim 2, wherein said heating device is provided with a laser beam emitting device for irradiating said resist surface with a laser beam.

5. An exposure system according to claim 3, wherein said laser beam emitting device is located outside said chamber, and irradiates said resist surface by directing said laser beam emitted therefrom to said resist surface through a laser beam transmissive member provided in said chamber.

6. An exposure system according to claim 4, wherein said laser beam emitting device is located outside said chamber, and irradiates said resist surface by directing said laser beam emitted therefrom to said resist surface through a laser beam transmissive member provided in said chamber.

7. An exposure system according to claim 2, wherein said heating device is provided with a laser beam emitting device for irradiating said resist surface with a laser beam, and
said laser beam emitting device irradiates said resist surface while said turn table is rotated by said drive device, whereby a region of said resist surface exposed by said exposure device is heated by following said exposure.

8. An exposure system according to claim 7, wherein said laser beam emitting device is located outside said chamber, and irradiates said resist surface by directing said laser beam emitted therefrom to said resist surface through a laser beam transmissive member provided in said chamber.

9. An exposure system according to claim 7, comprising a control device for controlling a relationship between a position for exposure to said optical or electron beam and a position for irradiation with said laser beam such that said region exposed to said optical or electron beam is irradiated with said laser beam after a predetermined time elapses from a reference time at which said region is exposed to said optical or electron beam.

10. An exposure system according to claim 8, comprising a control device for controlling a relationship between a position for exposure to said optical or electron beam and a position for irradiation with said laser beam such that said region exposed to said optical or electron beam is irradiated with said laser beam after a predetermined time elapses from a reference time at which said region is exposed to said optical or electron beam.

11. An exposure system according to claim 1, wherein said resist is a chemically amplified resist.

12. An exposure system according to claim 2, wherein said resist is a chemically amplified resist.

13. An exposure system according to claim 3, wherein said resist is a chemically amplified resist.

14. An exposure system according to claim 4, wherein said resist is a chemically amplified resist.

15. An exposure system according to claim 5, wherein said resist is a chemically amplified resist.

16. An exposure system according to claim 6, wherein said resist is a chemically amplified resist.

17. An exposure system according to claim 7, wherein said resist is a chemically amplified resist.

18. An exposure system according to claim 8, wherein said resist is a chemically amplified resist.

19. An exposure system according to claim 9, wherein said resist is a chemically amplified resist.

20. An exposure system according to claim 10, wherein said resist is a chemically amplified resist.
